(19) United States
(12) Patent Application Publication
(10) Pub. No.: US 2019/0094635 A1
(43) Pub. Date: Mar. 28, 2019

(54) ARRAY SUBSTRATE AND LIQUID CRYSTAL DISPLAY PANEL

(71) Applicant: Wuhan China Star Optoelectronics Technology Co., L, Wuhan ,Hubei (CN)

(72) Inventor: Chao ZHANG, Wuhan, Hubei (CN)

(73) Assignee: Wuhan China Star Optoelectronics Technology Co., L, Wuhan ,Hubei (CN)

(21) Appl. No.: 15/577,849

(22) PCT Filed: Oct. 31, 2017
(86) PCT No.: PCT/CN2017/108686

§ 371 Date: Nov. 29, 2017

(30) Foreign Application Priority Data
Sep. 26, 2017 (CN) 201710883547.4

(51) Int. Cl. G02F 1/1343; G02F 1/1337

(52) U.S. Cl. CPC G02F 1/134336; G02F 2001/134372; G02F 2201/123; G02F 1/1337

(57) ABSTRACT

The present invention provides an array substrate. The array substrate comprises: a bottom substrate, a common electrode layer covers on the bottom substrate, an insulating layer stacks on the common electrode layer, and a pixel electrode layer is located on the insulating layer. The pixel electrode layer comprises pixel electrodes arranged at intervals. A transparent-tapered stopper is disposed between the adjacent pixel electrodes. The shaft cross section of the transparent-tapered stopper in a direction perpendicular to the common electrode layer is triangular. Therefore, when a voltage is applied between the pixel electrode and the common electrode, the transparent-tapered stopper can prevent the liquid crystal molecules located nearby the edge of the pixel electrode from being biased toward the direction perpendicular to the common electrode layer. This makes the liquid crystal molecules in a flat lay state, so that the light transmittance of the relevant area would not be reduced.

### RELATED APPLICATIONS

The present application is a National Phase of International Application Number PCT/CN2017/108686, filed Oct. 31, 2017, and claims the priority of China Application No. 201710883547.4, filed Sep. 26, 2017.

### FIELD OF THE DISCLOSURE

The disclosure relates to a liquid crystal display technical field, and more particularly to an array substrate and a liquid crystal display panel.

### BACKGROUND

In recent years, liquid crystal display (LCD) technology is rapidly gaining popularity due to its unique advantages of low power consumption, low radiation, lightweight and convenient. The display modes of a liquid crystal display panel have Vertical Alignment (VA) type and Fringe Field Switching (FFS) type. Among them, the liquid crystal display panel in the FFS type is widely used because of its wide viewing angle and high aperture ratio.

As shown in FIG. 1, the FFS type utilizes the fringe field generated between the pixel electrode layer 11 and the common electrode layer 12. The pixel electrode layer 11 is on the top of the array substrate and the common electrode layer 12 is on the bottom of the array substrate. So that the liquid crystal molecules between the electrodes and above the electrodes can rotate on the plane parallel to the array substrate. After voltage is applied to the pixel electrode layer 11 and the common electrode layer 12, the liquid crystal molecules are affected by the electric field component Ey from the horizontal y-direction and affected by the electric field component Ez from the z-direction (the direction perpendicular to the plane of the common electrode). However, at the edge position of the pixel electrode layer 11, the liquid crystal molecules are strong affected by the electric field component Ez, This causes the liquid crystal molecules not only to rotate horizontally but also to be influenced by a greater vertical force. Taking a positive liquid crystal as an example, liquid crystal molecules unexpectedly stand up under the influence of the fringe electric field component Ez. This can cause light loss in the relevant area, thereby reducing the brightness of the white screen and thus reducing the contrast of the LCD panel.

### SUMMARY

In the light of this, the present invention provides an array substrate and a liquid crystal display panel for reducing the force of the liquid crystal molecules in the direction of perpendicular to the plane of the common electrode layer in an FFS type liquid crystal display panel, so as to improve the contrast of the panel.

In the first embodiment, the present invention provides an array substrate. The array substrate comprises a bottom substrate, a common electrode layer, an insulating layer, and a pixel electrode layer. The common electrode layer covers on the bottom substrate. The insulating layer stacks on the common electrode layer. The pixel electrode layer is located on the insulating layer. The pixel electrode layer comprises a plurality of pixel electrodes arranged in a matrix. Wherein, there is a transparent-tapered stopper disposed between the adjacent pixel electrodes. The shaft cross section of the transparent-tapered stopper in a direction perpendicular to the common electrode layer is triangular.

The function of the transparent-tapered stopper provided between adjacent pixel electrodes according to the present invention will be described below. When a voltage is applied between the pixel electrode layer and the common electrode layer, the transparent-tapered stopper prevent the liquid crystal molecules located nearby the edge of the pixel electrode from being biased toward the direction perpendicular to the common electrode layer. Therefore, these liquid crystal molecules can be as flat lay as possible. So that the light transmittance of the relevant area is not reduced.

In an embodiment, the base angle of said triangle of the shaft cross section is in the range of 30 degrees to 60 degrees. Even better is that the base angle is 45 degrees, The base angle of the transparent-tapered stopper with said range can effectively stress the liquid crystal molecules. So as to effectively prevent the liquid crystal molecules from being biased in the direction perpendicular to the common electrode layer.

In an embodiment, the vertex of the transparent-tapered stopper is equal to the distance between adjacent pixel electrodes. In other words, the shaft cross section is an isosceles triangle.

In an embodiment, the height of the transparent-tapered stopper is 8 times to 12 times of the thickness of the pixel electrode layer.

In an embodiment, the height of the transparent-tapered stopper is in the range of 0.8 μm to 1.2 μm, Even better is that the height of the transparent-tapered stopper is in the range of 0.9 μm to 1.1 μm.

In an embodiment, the base-side length of said triangle of the shaft cross section is 0.5 times to 0.6 times of the distance between the adjacent pixel electrodes.

In an embodiment, the transparent-tapered stopper is made of photosensitive negative photoresist. A transparent film of a predetermined thickness may be coated between adjacent pixel electrodes. Then exposing by using a mask of a predetermined shape (the shape of the light-transmitting region of the mask matches the shape of the transparent-tapered stopper). Finally, the transparent-tapered stopper is developed and formed between adjacent pixel electrodes.

Wherein, the pixel electrode layer and the common electrode layer are made of a transparent conductive material, said transparent conductive material is at least one selected from indium tin oxide, indium zinc oxide, aluminum-doped zinc oxide, fluorine-doped tin dioxide and phosphorus-doped tin dioxide.

In the second embodiment, the present invention provides a liquid crystal display panel. The liquid crystal display panel comprises a color filter substrate and the array substrate described in the first embodiment. The color filter substrate and the array substrate are disposed opposite to each other. There is a liquid crystal layer sandwiched between the color filter substrate and the array substrate.

The liquid crystal display panel according to the second embodiment of the present invention, the transparent-tapered stopper is disposed between adjacent pixel electrodes on the array substrate. When a voltage is applied between the pixel electrode layer and the common electrode layer, the transparent-tapered stopper prevents the liquid crystal molecules located nearby the edge of the pixel electrode from being biased toward the direction perpendicular to the common electrode layer. Therefore, these liquid crystal molecules can be as flat lay as possible. So that the light transmittance of the relevant area is not reduced. Further, the contrast of the liquid crystal display panel can also be improved.

### BRIEF DESCRIPTION OF THE DRAWINGS

FIG. 1 is a schematic view of the electric field driven liquid crystal molecules in the FFS type panel of the prior art; 11 is a pixel electrode, 12 is a common electrode, 13 is an insulating layer, and a dotted line represents an electric field line;

FIG. 2 is a cross-sectional view of a liquid crystal display panel in an embodiment of the present invention, and a dotted line represents an electric field line; and

FIG. 3 is a top view of the pixel electrode layer 24 on the insulating layer 23 in the embodiment of the present invention.

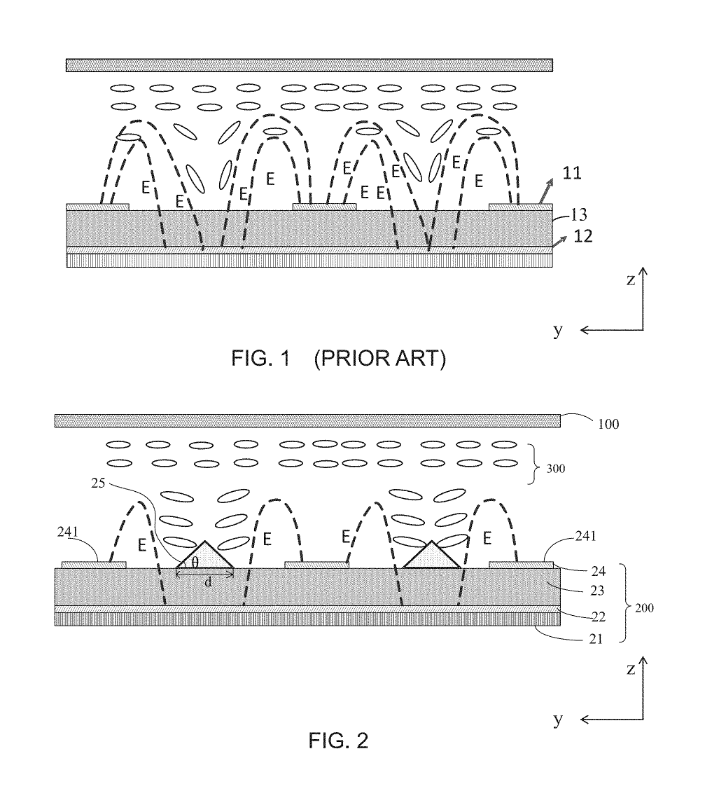

### DETAILED DESCRIPTION OF PREFERRED EMBODIMENTS

The disclosure will be further described in detail with reference to accompanying drawings and preferred embodiments as follows. The specific structural and functional details disclosed herein are only representative and are intended for describing exemplary embodiments of the disclosure. All other embodiments obtained by persons of ordinary skill in the art based on the embodiments of the present invention without creative efforts shall fall within the protection scope of the present invention. However, the disclosure can be embodied in many forms of substitution, and should not be interpreted as merely limited to the embodiments described herein.

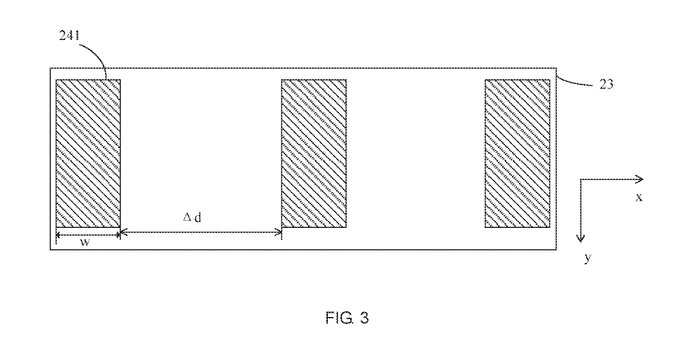

FIG. 2 is a cross-sectional view of a liquid crystal display panel in an embodiment of the present invention. The liquid crystal display panel comprises a color filter substrate 100, an array substrate 200, and a liquid crystal layer 300. The color filter substrate 100 and the array substrate 200 are disposed opposite to each other. The liquid crystal layer 300 is sandwiched between the color filter substrate 100 and the array substrate 200. The liquid crystal layer 300 includes a plurality of liquid crystal molecules aligned in a certain direction.

In the following, the disclosure will be further described in detail with reference to the array substrate 200 used in the liquid crystal display panel. The array substrate 200 is particularly suitable for the liquid crystal display panel in the FFS type.

As shown in FIG. 2, the array substrate 200 comprises a bottom substrate 21, a common electrode layer 22, an insulating layer 23, and a pixel electrode layer 24. The common electrode layer 22 covers on the bottom substrate 21. The insulating layer 23 is located on the common electrode layer 22. The pixel electrode layer 24 is located on the insulating layer 23. The pixel electrode layer 24 includes pixel electrodes 241 disposed at intervals. Wherein, a transparent-tapered stopper 25 is disposed between the adjacent pixel electrodes 241. The cross section of the transparent-tapered stopper 25 in the direction perpendicular to the common electrode layer 22 (i.e. parallel to the z-direction) is triangular.

In the present invention, the transparent-tapered stopper 25 is disposed between adjacent pixel electrodes 241. When the voltage is applied between the pixel electrode 241 and the common electrode layer 22. The transparent-tapered stopper 25 may prevent the liquid crystal molecules located nearby the edge of the pixel electrode 241 from being biased toward the direction perpendicular to the common electrode layer 22 (i.e. the z-direction in FIG. 2).

The shaft cross section of the transparent-tapered stopper 25 is triangular. The base angle θ of said triangle of the shaft cross section is in the range of 30 degrees to 60 degrees. The base angle θ of the transparent-tapered stopper 25 with said range can effectively stress the liquid crystal molecules. So as to effectively prevent the liquid crystal molecules from being biased in the direction perpendicular to the common electrode layer 22. Further, even better is that the base angle θ is 45 degrees.

In an embodiment, the shape of the transparent-tapered stopper 25 may be a cone, a pyramid (such as a triangular pyramid, a square based pyramid, etc.). Wherein, the vertex of the transparent-tapered stopper 25 is equal to the distance between adjacent pixel electrodes 241. The shaft cross section of the transparent-tapered stopper 25 is an isosceles triangle.

In the embodiment of the present invention, the transparent-tapered stopper 25 is disposed between the adjacent pixel electrodes 241. So obviously, the base-side length d in the triangle of the axial cross section of the transparent-tapered stopper 25 is smaller than the pitch Δd between the adjacent pixel electrodes 241. Further, the base-side length d within said triangle of the shaft cross section is 0.5 times to 0.6 times of the distance Δd between the adjacent pixel electrodes 241.

Furthermore, the transparent-tapered stopper 25 is tapered. The cross-section vertical z-direction of the transparent-tapered stopper 25 gradually decreases along the direction from the bottom substrate 21 toward the insulating layer 23 (i.e. the z-direction in FIG. 2). The maximum width of the cross section of the transparent-tapered stopper 25 is also smaller than the pitch Δd of the adjacent pixel electrodes 241. Further, the maximum width of the cross section of the transparent-tapered stopper 25 is 0.5 times to 0.6 times the pitch Δd of the adjacent pixel electrodes 241.

Can be used as an example. The height of the transparent-tapered stopper 25 is 8 times to 12 times of the thickness of the pixel electrode layer 24. Further the height of the transparent-tapered stopper 25 is in the range of 0.8 μm to 1.2 μm, preferably the height of the transparent-tapered stopper is in the range of 0.9 μm to 1.1 μm. This has the effect of better preventing the liquid crystal molecules from being deflected in the z-direction.

FIG. 3 is a top view of the pixel electrode layer 24 in the present invention. As shown in FIG. 3, the pixel electrode layer 24 comprises a plurality of pixel electrodes 241 arranged in a matrix. The pixel electrode 241 is in a strip shape. The pitch Δd of the adjacent pixel electrodes 241 is in the range of 3.6 μm to 4.2 μm. The width w of the pixel electrode 241 is in the range of 2.8 μm to 3.4 μm.

In an embodiment of the present invention, the pitch Δd of the adjacent pixel electrodes 241 is 3.9 μm. The width of the pixel electrode 241 is 3.1 μm. The maximum width d of the transparent-tapered stopper 25 is 2.0 μm. The distances between the transparent-tapered stopper 25 and any of these two adjacent pixel electrodes 241 on the opposite sides are respectively 0.95 μm.

The transparent-tapered stopper 25 is made of photosensitive negative photoresist. A transparent film of a predetermined thickness may be coated between adjacent pixel electrodes 241. Then exposing by using a mask of a predetermined shape (the shape of the light-transmitting region of the mask matches the shape of the transparent-tapered stopper 25). Finally, the transparent-tapered stopper 25 is developed and formed between adjacent pixel electrodes 241.

The pixel electrode layer 24 and the common electrode layer 22 are made of a transparent conductive material. Said transparent conductive material is at least one selected from Indium Tin Oxide (ITO), Indium Zinc Oxide (IZO), Aluminum-doped Zinc Oxide (AZO), Fluorine-doped Tin Dioxide (FTO) and Phosphorus-doped Tin Dioxide (PTO).

Wherein, the common electrode layer 22 is a planar electrode, and covers on the entire surface of the bottom substrate 21.

In the array substrate 200 provided by the embodiment of the present invention, the transparent-tapered stopper 25 is disposed between the adjacent pixel electrodes 241. When a voltage is applied between the pixel electrode 241 and the common electrode layer 22, the transparent-tapered stopper 25 can prevent the liquid crystal molecules located nearby the edge of the pixel electrode 241 from being deflected in the z-direction. Therefore, the liquid crystal molecules can be kept as lying as possible, so that the liquid crystal molecules rotate parallel to the plane (x-y plane) of the array substrate 200. The light transmittance in the edge region of the pixel electrode 241 will not be reduced.

In the liquid crystal display panel provided in FIG. 2. The color filter substrate 100 is a substrate commonly used in the field of liquid crystal display technology. The specific structure of the color filter substrate 100 also a conventional technique. So the color filter substrate 100 will not be described in detail.

As for the array substrate 200, in addition to having the structure shown in FIG. 2, other conventional structures may be included. For example, the planarization layer on the pixel electrode 241, the liquid crystal alignment film on the planarization layer, and the like. Or, for example, the liquid crystal material constituting the liquid crystal layer 300 may be coated to the liquid crystal alignment film region on the array substrate 200.

The liquid crystal molecules in the liquid crystal layer 300 may be positive nematic liquid crystals having dielectric anisotropy. For example, dicyanobenzene liquid crystal, pyridazine liquid crystal, schiff base liquid crystal, azoxy liquid crystal, biphenyl liquid crystal, phenyl cyclohexane liquid crystal, pyrimidine liquid crystal, dioxane liquid crystal, bicyclooctane liquid crystal, cubane liquid crystal and the like, but not limited thereto.

In the FFS type of the liquid crystal display panel in the FIG. 2. The transparent-tapered stopper 25 is disposed between the adjacent pixel electrodes 241 on the array substrate 200. When the voltage is applied between the pixel electrode 241 and the common electrode layer 22. The transparent-tapered stopper 25 may prevent the liquid crystal molecules located nearby the edge of the pixel electrode 241 from being deflected in the z-direction. Therefore, the liquid crystal molecules can be kept as lying as possible, so that the liquid crystal molecules rotate parallel to the plane (x-y plane) of the array substrate 200. The light transmittance in the edge region of the pixel electrode 241 will not be reduced. So as this invention can prevent the brightness of the white screen from reducing, thereby also can improve the contrast of the liquid crystal display panel. Wherein, said comparison is the ratio of the brightness of the all-white screen to the brightness of the all-black screen.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application. In addition, although some specific terms are used in this specification, these terms are merely for convenience of description and do not limit the present invention in any way.

1. An array substrate, comprising:
a bottom substrate;
a common electrode layer, disposed on the bottom substrate;
an insulating layer, stacked on the common electrode layer; and
a pixel electrode layer, located on the insulating layer;
wherein the pixel electrode layer comprises a plurality of pixel electrodes arranged in a matrix, a transparent-tapered stopper is disposed between the adjacent pixel electrodes, the shaft cross section of the transparent-tapered stopper in a direction perpendicular to the common electrode layer is triangular.

2. The array substrate according to claim 1, wherein the base angle of said triangle of the shaft cross section is in the range of 30 degrees to 60 degrees.

3. The array substrate according to claim 2, wherein the base angle of said triangle of the shaft cross section is 45 degrees.

4. The array substrate according to claim 1, wherein the vertex of the transparent-tapered stopper is placed with equal distance between the adjacent pixel electrodes.

5. The array substrate according to claim 1, wherein the height of the transparent-tapered stopper is 8 times to 12 times of the thickness of the pixel electrode layer.

6. The array substrate according to claim 5, wherein the height of the transparent-tapered stopper is in the range of 0.8 μm to 1.2 μm.

7. The array substrate according to claim 5, wherein the height of the transparent-tapered stopper is in the range of 0.9 μm to 1.1 μm.

8. The array substrate according to claim 1, wherein the base-side length of said triangle of the shaft cross section is 0.5 times to 0.6 times of the distance between the adjacent pixel electrodes.

9. The array substrate according to claim 1, wherein the cross section of the transparent-tapered stopper is gradually reduced along the direction of the bottom substrate toward the insulating layer.

10. The array substrate according to claim 9, wherein the maximum width of the shaft cross section of the transparent-tapered stopper is 0.5 times to 0.6 times of the pitch between adjacent pixel electrodes.

11. The array substrate according to claim 4, wherein the pitch of adjacent pixel electrodes is in the range of 3.6 μm to 4.2 μm.

12. The array substrate according to claim 8, wherein the pitch of adjacent pixel electrodes is in the range of 3.6 μm to 4.2 μm.

13. The array substrate according to claim 1, wherein the width of the pixel electrode is in the range of 2.8 μm to 3.4 μm.

14. The array substrate according to claim 1, wherein the transparent-tapered stopper is made of photosensitive negative photoresist.

15. The array substrate according to claim 1, wherein the pixel electrode layer is made of a transparent conductive material, said transparent conductive material is at least one selected from indium tin oxide, indium zinc oxide, aluminum-doped zinc oxide, fluorine-doped tin dioxide and phosphorus-doped tin dioxide.

16. The array substrate according to claim 1, wherein the common electrode layer is made of a transparent conductive material, said transparent conductive material is at least one selected from indium tin oxide, indium zinc oxide, aluminum-doped zinc oxide, fluorine-doped tin dioxide and phosphorus-doped tin dioxide.

17. A liquid crystal display panel, comprising a color filter substrate and an array substrate opposite to each other, and comprising a liquid crystal layer sandwiched between the color filter substrate and the array substrate,
the array substrate comprising: a bottom substrate, a common electrode layer, an insulating layer, and a pixel electrode layer,
the common electrode layer disposed on the bottom substrate,
the insulating layer stacked on the common electrode layer,
the pixel electrode layer located on the insulating layer,
wherein the pixel electrode layer comprises a plurality of pixel electrodes arranged in a matrix, a transparent-tapered stopper is disposed between the adjacent pixel electrodes, the shaft cross section of the transparent-tapered stopper in a direction perpendicular to the common electrode layer is triangular.

18. The liquid crystal display panel according to claim 17, wherein the base angle of said triangle of the shaft cross section is in the range of 30 degrees to 60 degrees.

19. The liquid crystal display panel according to claim 17, wherein the height of the transparent-tapered stopper is 8 times to 12 times of the thickness of the pixel electrode layer.

20. The liquid crystal display panel according to claim 17, wherein the transparent-tapered stopper is made of photosensitive negative photoresist.
